(19) United States
(12) Patent Application Publication
(10) Pub. No.: US 2015/0013084 A1
(43) Pub. Date: Jan. 15, 2015

(54) Unloading and loading device

(71) Applicant: Roy Burrow, Woodlawn, MD (US)

(72) Inventor: Roy Burrow, Woodlawn, MD (US)

(21) Appl. No.: 13/941,626

(22) Filed: Jul. 15, 2013

(51) Int. Cl. B65G 69/30

(52) U.S. Cl. CPC B65G 69/30
USPC 14/72.5

(57) ABSTRACT

An unloading device to unload an object includes a mainframe device having a mainframe bottom wall and a pallet Jack device to lift the mainframe device. The mainframe device may include a bulkhead plate which pivots with respect to the mainframe bottom wall. The pallet Jack device may include a pair of opposing pallet Jack legs to lift the mainframe device.

### FIELD OF THE INVENTION

The present invention relates to pallet carriers and more particularly to an unloading device.

### BACKGROUND

Trays and pallets may be stacked or may be positioned at a location which may not be easily reached by unaided individuals. The trays and pallets may be stacked to high levels requiring a step ladder or other height adjustment device in order for the trays and pallets to be reached. The trays and pallets may be loaded with other objects such as food or other objects which need to be transferred to another location. Furthermore, there is a need to quickly and efficiently bring these trays and pallets to a surface level where they can be easily removed.

U.S. Pat. No. 8,191,338 discloses an inserting apparatus for placing a product in an envelope being provided with a discharge path. The discharge path is provided with a skewed roller conveyer which comprises a plurality of rollers arranged at an angle relative to the discharge conveying direction, to align the envelopes along a stop extending in the conveying direction of the roller conveyer. The discharge path is provided with at least one pressing device extending above the roller conveyor to press envelopes towards the roller conveyor, the pressing device comprising at least one array of vertically moveable, rotatable balls. The roller conveyor is provided with at least one endless transport belt for the envelopes, extending opposite the at least one pressing device, the endless belt extending substantially transversally with respect to the rollers.

U.S. Pat. No. 6,796,456 discloses a method and apparatus of registering two sheets, such as wood veneer sheets. According to the method, firstly two sheets are assembled together by laying one sheet on top of the other sheet in an overlapped relation to each other wherein one end of the upper sheet is positioned outward of one end of the lower sheet. Then, the two sheets thus assembled are moved by a conveyer in the above overlapped relation in such an orientation that the above ends are moved as the leading ends. For registration of the sheets, there is provided a stop device having a stop surface extending perpendicularly to the direction in which the sheets are moved by the conveyer. On the way of movement of the sheets, firstly the upper sheet is stopped by the stop surface with the leading end thereof aligned against the stop surface, and subsequently the lower sheet is stopped by the stop surface with the leading end thereof aligned against the same stop surface. Thus, both sheets are registered with the leading ends thereof aligned properly against the stop surface of the stop device.

U.S. Pat. No. 5,568,857 discloses an improved roller conveyer for conveying objects is disclosed. It includes: (a) a fixed conveyer section having first parallel frames supported on upright stands and a plurality of first parallel rollers mounted between the first parallel frames of the fixed conveyer section; (b) a power drive for rotating the first parallel rollers of the fixed conveyer section when conveying objects; (c) a liftable conveyer section having second parallel frames and a plurality of second parallel rollers mounted between the second parallel frames of the liftable conveyer section. The liftable conveyer section has: (a) a fixed end pivoted to one end of the fixed conveyer section and a free end; (b) a transmission mechanism mounted on the liftable conveyer section for rotating the second parallel rollers of the liftable conveyer section; (c) a clutch member mounted on the liftable conveyer section couple the transmission mechanism with the power drive; and (d) a plurality of gas spring levers and springs respectively mounted on the liftable conveyer section to provide resistance to the liftable conveyer section when it is down-lifted. The transmission mechanism is coupled to the power drive by the clutch member when the liftable conveyer section is not lifted, and the transmission mechanism is disconnected from the power drive when the liftable conveyer section is lifted from the fixed conveyer section.

The above patents are incorporated by reference in their entirety.

### SUMMARY

An unloading device to unload an object includes a mainframe device having a mainframe bottom wall and a pallet Jack device to lift the mainframe device. The mainframe device may include a bulkhead plate which pivots with respect to the mainframe bottom wall.

The pallet Jack device may include a pair of opposing pallet Jack legs to lift the mainframe device.

The mainframe device may include an overhang sidewall to cooperate with the pallet Jack legs.

The pallet lifting device may include a pivoting arm to lift the pallet lifting device.

The mainframe device may include a roller to move the object.

The mainframe device may include a stop device to stop the object.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the unloading device of the present invention in a first or lowered position;

FIG. 2 illustrates a side view of the unloading device of the present invention in a second or raised position;

FIG. 3 illustrates a top view of the unloading device of the present invention;

FIG. 4 illustrates a back view of the unloading device of the present invention;

FIG. 5 illustrates a front view of the unloading device of the present invention.

### DETAILED DESCRIPTION

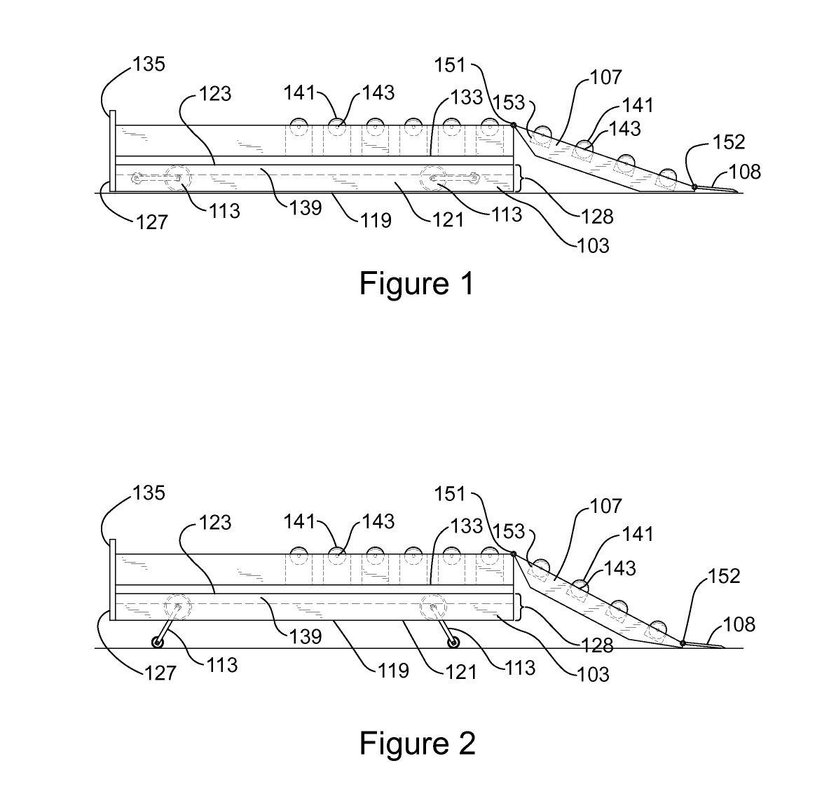

FIG. 1 illustrates the unloading device 100 of the present invention which may include a pallet jack device 103, a main frame device 105 and a pivotable and detachable bulkhead plate 107. FIG. 1 illustrates that the unloading device 100 of the present invention is in a first position which may be lowered position.

The pallet jack device 103 may be positioned on a support surface 109 which may be the ground or floor of a building and which may include a first pivoting arm 111 and a second pivoting arm 113 which may mirror the first pivoting arm 111 to raise and lower the pallet jack device 103 and raise and lower the mainframe device 105 which may be positioned over the pallet jack device 103. The first pivoting arm 111 and the second pivoting arm 113 may be pivotably connected to the pallet jack device 103 and may rotate with respect to the pallet jack device 103 to raise and lower the pallet jack device 103.

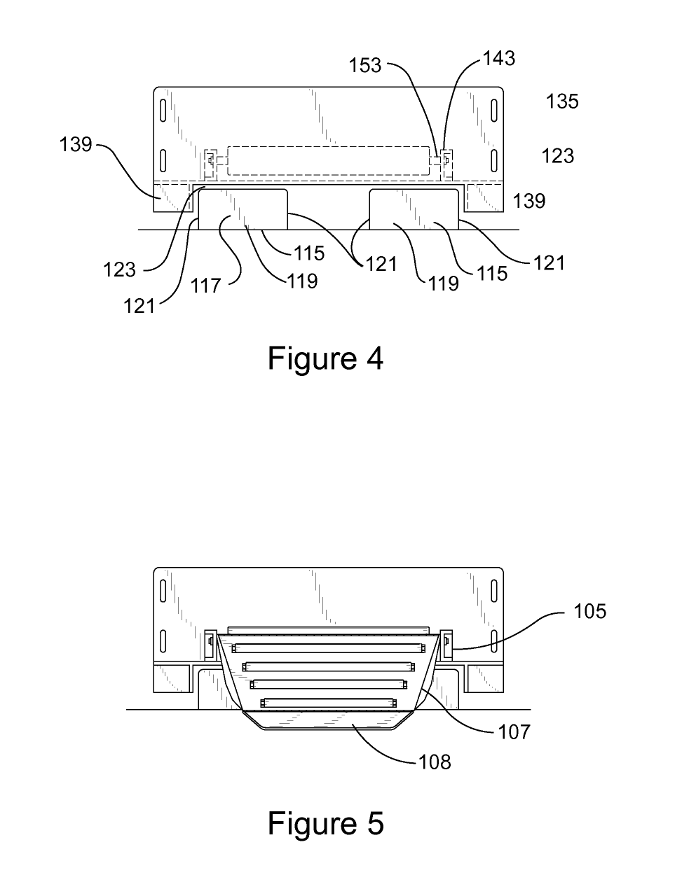

The pallet jack device 103 may include a first pallet lifting device 115 and a substantially mirror second pallet lifting device 117 shown best in FIG. 4. The first and second pallet lifting device 115, 117 each may respectively be a substantial rectangle or other appropriate device and may include a pallet bottom wall 119 which may be connected to a pallet sidewall 121, the pallet front wall 125 and the pallet back wall 127. The pallet top wall 123 may be opposed to the pallet bottom wall and 119 and may be connected to the pallet sidewall 121, the pallet front wall 125 and the pallet back wall 127. The first pallet lifting device 115 and the second pallet lifting device 117 may be solid or hollow.

The main frame device 105 may include a mainframe bottom wall 133 which may be connected to the mainframe sidewall 131 and may be connected to the mainframe back wall 135. The mainframe sidewall 131 may extend upwards in order to prevent objects from falling off and the mainframe back wall 135 may extend upwards in order to prevent objects from falling off.

The mainframe device 105 may include an overhang sidewall 139 which may be connected to the mainframe bottom wall 133 and may extend downwards in order to cooperate with the first and second pallet lifting device 115, 116 to guide the mainframe device 105.

The mainframe device 105 may include longitudinal rollers 141 which may extend traverse to the mainframe device 105 and which may include a central shaft 143 to allow the rollers 141 to rotate. The central shaft 143 may be rotatably connected to a mainframe bracket 143 which may be positioned on opposing sides of the mainframe device 105 and which may be connected to the mainframe bottom wall 133 so that objects which may be placed on the mainframe device 105 may be moved along the rollers 141.

FIG. 1 additionally illustrates a first bulkhead plate 107 which may be truncated tapered and which may pivot with respect to the mainframe device 105 by virtue of a removable pin/hinge (shaft) 151. The bulkhead plate 107 may include rollers 141 which may rotate about the central shaft 143 which may be connected to a bracket 153. FIG. 1 illustrates that the unloading device 100 may include a second bulkhead plate 108 which may be pivotably connected to the first bulkhead plate 107 by virtue of a hinge 152 so that the second bulkhead plate 108 may pivot with respect to the first bulkhead plate 107 in order to provide a smooth transition to the support surface 109.

FIG. 2 illustrates the unloading device 100 of the present invention which may include a pallet jack device 103, a main frame device 105 and a pivotable and detachable bulkhead plate 107. FIG. 2 illustrates that the unloading device 100 of the present invention may be in a second position which may be a raised position in order to access objects which may be at a elevated position.

The pallet jack device 103 may be positioned above a support surface 109 which may be the ground or floor of a building and which may include a first pivoting arm 111 and a second pivoting arm 113 which may mirror the first pivoting arm 111 to raise and lower the pallet jack device 103 and raise and lower the mainframe device 105 which may be positioned over the pallet jack device 103. The first pivoting arm 111 and the second pivoting arm 113 may be pivotably connected to the pallet jack device 103 and may rotate with respect to the pallet jack device 103 to raise and lower the pallet jack device 103.

The pallet jack device 103 may include a first pallet lifting device 115 and a substantially mirror second pallet lifting device 117 shown best in FIG. 4. The first and second pallet lifting device 115, 117 each may respectively be a substantial rectangle or other appropriate device and may include a pallet bottom wall 119 which may be connected to a pallet sidewall 121, the pallet front wall 125 and the pallet back wall 127. The pallet top wall 123 may be opposed to the pallet bottom wall and 119 and may be connected to the pallet sidewall 121, the pallet front wall 125 and the pallet back wall 127. The first pallet lifting device 115 and the second pallet lifting device 117 may be solid or hollow.

The main frame device 105 may include a mainframe bottom wall 133 which may be connected to the mainframe sidewall 131 and may be connected to the mainframe back wall 135. The mainframe sidewall 131 may extend upwards in order to prevent objects from falling off and the mainframe back wall 135 may extend upwards in order to prevent objects from falling off.

The mainframe device 105 may include an overhang sidewall 139 which may be connected to the mainframe bottom wall 133 and may extend downwards in order to cooperate with the first and second pallet lifting device 115, 116 to guide the mainframe device 105.

The mainframe device 105 may include longitudinal rollers 141 which may extend traverse to the mainframe device 105 and which may include a central shaft 143 to allow the rollers 141 to rotate. The central shaft 143 may be rotatably connected to a mainframe bracket 143 which may be positioned on opposing sides of the mainframe device 105 and which may be connected to the mainframe bottom wall 133 so that objects which may be placed on the mainframe device 105 may be moved along the rollers 141.

FIG. 2 additionally illustrates a first bulkhead plate 107 which may be truncated tapered and which may pivot with respect to the mainframe device 105 by virtue of a removable pin/hinge (shaft) 151. The bulkhead plate 107 may include rollers 141 which may rotate about the central shaft 143 which may be connected to a bracket 153.

FIG. 2 illustrates that the unloading device 100 may include a second bulkhead plate 108 which may be pivotably connected to the first bulkhead plate 107 by virtue of a hinge 152 so that the second bulkhead plate 108 may pivot with respect to the first bulkhead plate 107 in order to provide a smooth transition to the support surface 109.

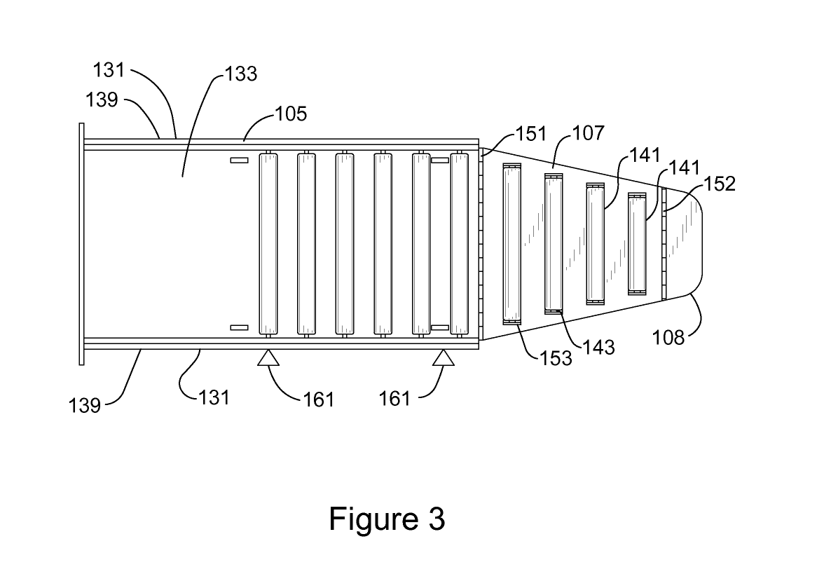

FIG. 3 illustrates a first bulkhead plate 107 which may be truncated tapered and which may pivot with respect to the mainframe device 105 by virtue of a removable pin/hinge (shaft) 151. The bulkhead plate 107 may include rollers 141 which may rotate about the central shaft 143 which may be connected to a bracket 153.

FIG. 3 illustrates that the unloading device 100 may include a second bulkhead plate 108 which may be pivotably connected to the first bulkhead plate 107 by virtue of a hinge 152 so that the second bulkhead plate 108 may pivot with respect to the first bulkhead plate 107 in order to provide a smooth transition to the support surface 109.

The main frame device 105 may include a mainframe bottom wall 133 which may be connected to the mainframe sidewall 131 and may be connected to the mainframe back wall 135. The mainframe sidewall 131 may extend upwards in order to prevent objects from falling off and the mainframe back wall 135 may extend upwards in order to prevent objects from falling off. The mainframe device 105 may include a stopping device 161 to stop the objects on the mainframe device 105.

The mainframe device 105 may include an overhang sidewall 139 which may be connected to the mainframe bottom wall 133 and may extend downwards in order to cooperate with the first and second pallet lifting device 115, 116 to guide the mainframe device 105.

FIG. 4 illustrates the first pallet lifting device 115, the second pallet lifting device 117, the pallet bottom wall 119, the pallet sidewall 121, the top wall 123, the mainframe back wall 135 and the overhang sidewall 139. In addition, FIG. 4 illustrates the mainframe bracket 143, the roller 141 and the central shaft 153.

FIG. 5 illustrates a front view of the mainframe device 105, the first bulkhead plate 107, and the second bulkhead plate 108.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An unloading device to unload an object, comprising
a mainframe device having a mainframe bottom wall;
a pallet Jack device to lift the mainframe device;
wherein the mainframe device includes a bulkhead plate which pivots with respect to the mainframe bottom wall.

2. An unloading device to unload an object as in claim 1, wherein the pallet Jack device includes a pair of opposing pallet Jack legs to lift the mainframe device.

3. An unloading device to unload an object as in claim 2, where in the mainframe device includes a overhang sidewall to cooperate with the pallet Jack legs.

4. An unloading device to unload an object as in claim 1, where in the pallet lifting device includes a pivoting arm to lift the pallet lifting device.

5. An unloading device to unload an object as in claim 1, wherein the mainframe device includes a roller to move the object.

6. An unloading device to unload an object as in claim 1, wherein the mainframe device includes a stop device to stop the object.
